(19) United States
(12) Patent Application Publication
(10) Pub. No.: US 2021/0073738 A1
(43) Pub. Date: Mar. 11, 2021

(54) COGNITIVE APPLICATION REVIEWER

(71) Applicant: INTERNATIONAL BUSINESS MACHINES CORPORATION, ARMONK, NY (US)

(72) Inventors: Michael Bender, Rye Brook, NY (US); Michael Patrick Shute, Niantic, CT (US); Siddhartha Sood, Indirapuram (IN); Gordan G. Greenlee, Endicott, NY (US)

(21) Appl. No.: 16/563,028

(22) Filed: Sep. 6, 2019

(51) Int. Cl. G06Q 10/10; G06F 16/9536; G06F 16/9535; G06F 16/906

(52) U.S. Cl. CPC G06Q 10/1053; G06F 16/906; G06F 16/9535; G06F 16/9536

(57) ABSTRACT

A method, computer system, and a computer program product for cognitive application review is provided. Embodiments may include receiving, by a processor, an applicant's application based on a job description; collecting, by the processor, publicly available education information; collecting, by the processor, publicly available information about the applicant; comparing, by the processor, the publicly available information about the applicant, as well as information included on the applicant's application, to the job description; comparing, by the processor, one or more skills and achievements of the applicant to one or more skills and achievements of other applicants; rating, by the processor, one or more qualities, including a leadership quality, of the applicant; ranking, by the processor, the applicant, based on the one or more rated qualities; identifying, by the processor, a low ranking applicant and providing feedback to the low ranking applicant; and recommending a high ranking applicant to an administrator.

### BACKGROUND

The present invention relates generally to the field of computing, and more particularly to applicant tracking systems.

Applications (e.g., for a job or other posting) may be easily submitted online, and it may be common for businesses to receive large volumes of applications for a single position. As a result, human resources departments may employ applicant tracking (AT) systems to track job applicants. These AT systems may filter candidate resumes based on key words.

### SUMMARY

Embodiments of the present invention disclose a method, computer system, and a computer program product for cognitive application review. Embodiments may include receiving, by a processor, an applicant's application based on a job description; collecting, by the processor, publicly available education information; collecting, by the processor, publicly available information about the applicant; comparing, by the processor, the publicly available information about the applicant, as well as information included on the applicant's application, to the job description; comparing, by the processor, one or more skills and achievements of the applicant to one or more skills and achievements of other applicants; rating, by the processor, one or more qualities, including a leadership quality, of the applicant; ranking, by the processor, the applicant, based on the one or more rated qualities; identifying, by the processor, a low ranking applicant and providing feedback to the low ranking applicant; and recommending a high ranking applicant to an administrator.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIGS. 2A and 2B is an operational flowchart illustrating a process for cognitive application review according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for cognitively reviewing applications. As such, the present embodiment has the capacity to improve the technical field of applicant tracking systems by using cognitive techniques and by collecting information about an applicant and a position, comparing the applicant's skills and achievements to those specified within the job description, comparing the applicant's skills and achievements to other applicants, rating the applicant's leadership skills, ranking all applicants, and providing meaningful feedback to each applicant based on this analysis. More specifically, embodiments may include collecting publicly available education information, an applicant's information, and a job description. Embodiments may include comparing the applicant's information with the job description. Embodiments may include comparing the applicant's skills and achievements with other applicants. Embodiments may include rating the applicant's leadership. Embodiments may include ranking applicants based on weighted averages. Embodiments may include identifying low ranking applicants and providing feedback to the low-ranking applicants. Embodiments may include identifying and recommending high ranking applicants to administrator.

As described previously, applications (e.g., for a job or other posting) may be easily submitted online, and it may be common for businesses to receive large volumes of applications for a single position. As a result, human resources departments may employ applicant tracking (AT) systems to track job applicants. These AT systems may filter candidate resumes based on key words. However, the filtering of candidate resumes based on key words may not capture differentiating aspects of an applicant's application. That may be because a line item in an application or resume may not be quantified or qualified, a completion of an online class may be different than getting an A in a college class, or, a product certification may show more skill than a class completion. At times, professional certifications and/or published papers may even be considered more important than class and/or product certifications. Many times, having thorough leadership on a subject is not only determinable by academic qualifications such as classes and certifications, but through an assessment of leadership quality, including but not limited to mentoring, teaching, speaking, patenting, and/or publishing. Each application may have unique details that may depend on the context within the application. There may be a clear need to assess the contextual relevance of an individual's application in order to discover a suitable applicant.

It may also be important for an applicant to understand whether the applicant's application is competitive for a given position, and what factors may be weighing in on any such determination. An applicant may find that the applicant's skills and/or qualities may not have been documented and/or presented in a way which seeks the best chance of success. In this instance, among others, there may be a clear need to inform applicants of the determination and to suggest to applicants a path towards a more successful outcome in the future.

As a result, the highly competitive applicants may be difficult to determine, and businesses may discount qualified applicants due to a large volume of applications. While there may be many qualified applicants for a given position, some applicants may appear to be more qualified than others. At times even, a competitive applicant may not be accurately represented by the applicant's application. Therefore, it may be advantageous to, among other things, utilize cognitive techniques to collect information about an applicant and a position, compare the applicant's skills and achievements to those specified within the job description, compare the applicant's skills and achievements to other applicants, rate the applicant's leadership skills, rank all applicants, and provide meaningful feedback to each applicant based on this analysis.

According to at least one embodiment, the present invention may collect publicly available education information. The cognitive application review program 110a, 110b may search public datastores (e.g., a public storage entity usually used as a repository for data) and may gather a corpus of data from public sources that may be used for analysis. A datastore may exist to store any publicly available information that may have been gathered in prior instances of the cognitive application review program 110a, 110b. Publicly available education information may be used to rate an applicant's educational background. Publicly available education information may also be used to recommend possible educational opportunities to applicants which may be included within the feedback provided to an applicant.

According to at least one embodiment, the present invention may collect available information about the applicant, including, but not limited to, an application in response to a posting, one or more social network accounts, and/or any publicly available information. The applicant's application may consist of a resume and/or another form of input from the applicant (e.g., a course completion certificate and/or a letter of recommendation). The application may include an educational history, a job history, and any experience of the applicant, including but not limited to skills, certifications, awards, and/or achievements. Publicly available information and social networks including publications, articles, patents, and blogs may be collected. A datastore may exist to store any applicant information that may be gathered. The present invention may store gathered information in said datastore (i.e., in a private datastore). The present invention may extract an applicant's skills and/or achievements, among other relevant pieces of information, from the applicant's application that may be contained within the text of a resume, publication, or blogs, among other things, using natural language processing techniques. An application programming interface (API) may be utilized to parse the text and extract an applicant's information, such as Watson™ (Watson and all Watson-based trademarks are trademarks or registered trademarks of International Business Machines Corporation in the United States, and/or other countries) application program interfaces (APIs). For example, a natural language classifier API (e.g., Watson™ Natural Language Classifier API) may be used.

According to at least one embodiment, the present invention may collect a job description from a job posting (i.e., a position) which the applicant is applying to. The job description may be posted by a company looking to hire a new applicant. The job description may include any skills, qualifications and/or experience needed for the posted job. The present invention may extract the needed skills, qualifications and/or experiences for the posted job that may be contained within the text of a job posting using natural language processing techniques. An application programming interface (API), such as a Watson™ (Watson and all Watson-based trademarks are trademarks or registered trademarks of International Business Machines Corporation in the United States, and/or other countries) application program interface (API) (e.g., a natural language classifier API such as Watson™ Natural Language Classifier API) may be utilized to parse the text and extract information from the job posting.

According to at least one embodiment, the present invention may compare the information of the applicant to the requirements (e.g., skills, qualifications, and/or experiences) required to be demonstrated by an applicant for the posted job. The information of the applicant may be compared to the requirements of the posted job by calculating a rating for each category (e.g., education, skills, qualifications, achievements, leadership) based on the requirements (e.g., skills, qualifications, experiences) of the posted job. The invention may have various specific categories that may weighed to create an overall score for an applicant. Categories that may be assessed may include, but may not be limited to, education, skills, qualifications, achievements, and leadership. Categories may be set by a user or administrator when creating the job posting and a priority of each category may also be set by a user or administrator. Each category may be rated based on a maximum number which may be determined by a user or administrator (e.g., a rating may be out of 10). The administrator may also decide to weigh certain categories differently based on a preference for the specific job posting. The administrator may choose to configure the categories when creating the job posting. The applicant may be compared to the requirements for a posted job (i.e., a job posting, a position) by rating the categories (e.g., educations, skills, qualifications, achievements, leadership) that may have been defined by the administrator.

According to at least one embodiment, the present invention may compare the skills, qualifications, and/or experiences of the applicant to the skills, qualifications, and/or experiences of other applicants for the same and/or a similar posted job. A posted job may be determined to be similar to one or more other posted jobs based on an analysis of the skills, qualifications, and/or experiences extracted from the job description(s). The skills, qualifications, and/or experiences of applicants considered for one job may be shown in a related job and used as a means for comparison between multiple applications.

According to at least one embodiment, the present invention may compare achievements of the applicant to achievements of other applicants for the same and/or a similar posted job. A posted job may be determined to be similar to one or more other posted jobs based on an analysis of the skills, qualifications and/or experiences extracted from the job description(s). The achievements of applicants considered for one job may be shown in a related job and used as a means for comparison between multiple applications.

According to at least one embodiment, the present invention may use social networking to identify and rate the leadership qualities and/or skills of an applicant (e.g., any leadership initiatives undertaken by the applicant). The cognitive application review program 110a, 110b may ingest datastore(s) that have publicly available information (e.g., social networks, blogs, historical work reports). The cognitive application review program 110a, 110b may be used with non-public datastores that the cognitive application review program 110a, 110b may have a partnership. Natural language processing techniques may be used to identify applicants, based on data within the ingested datastore(s), that may be early and/or late on tasks (i.e., timeliness of tasks). Natural language processing techniques may also be used to analyze the personality of the applicants, such as identifying individuals that may be inclined to assist others on tasks (i.e., assisting others). Natural language processing techniques, such as those implemented in Watson™ (Watson and all Watson-based trademarks are trademarks or registered trademarks of International Business Machines Corporation in the United States, and/or other countries) application program interfaces (APIs) (e.g., a personality insights API such as Watson™ Personality Insights API) may be used by embodiments of the present invention. An applicant's leadership rating may be determined by weighing the above qualities and/or skills, based on data from the ingested datastore(s), as well as information gathered from the applicant's collected information.

According to at least one embodiment, the present invention may rank applicants based on weighted averages. Applicants may be re-ranked each time a new applicant applies for a given job posting (i.e., position). The weighted averages may include all the categories that are being analyzed which may include skills and/or experiences, relative to the job posting, as well as education, leadership qualities, etc. An administrator or individual working on behalf of a company posting a given role may decide how to weigh the above categories for a specific job posting.

According to at least one embodiment, the present invention may determine whether an applicant has a low ranking. A low ranking may be comparatively low as compared to the rankings of other applicants who may have applied for the same or a similar posting (i.e., a posted job). The present invention may provide feedback to applicants based on the applicant's ranking. In some instances, only applicants with low rankings may receive feedback, while in other instances, all applicants may receive feedback, regardless of a determined ranking. In the latter instance, a higher ranking applicant's feedback may differ from a lower ranking applicant's feedback in that it may include fewer areas for improvement.

According to at least one embodiment, the present invention may provide feedback to applicants determined to have a comparatively low ranking. A low ranking may be a comparatively low ranking as compared to the rankings of other applicants who may have applied for the same or a similar posting (i.e., a posted job). Feedback may include an identification of areas that may lack details in the application and/or a suggestion of future educational opportunities, among other things.

According to at least one embodiment, the present invention may recommend comparatively high-ranking applicants to a recruiter and/or another individual who may have posted the position (i.e., the posting, the posted job). A high ranking may be a comparatively high ranking as compared to the rankings of other applicants who may have applied for the same or a similar position (i.e., the posting, the posted job). The recommended applicants may be recommended to interview for the position first, or before an applicant with a lower ranking.

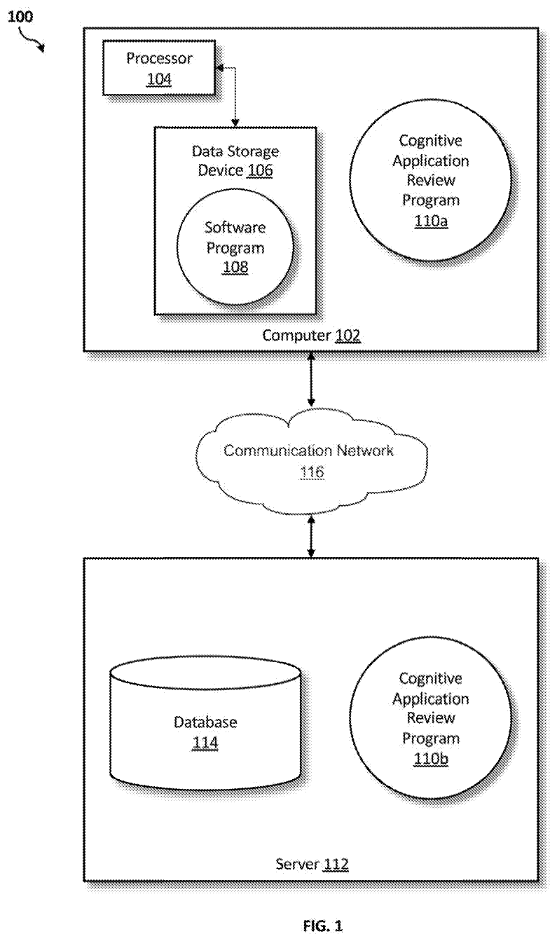

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a cognitive application review program 110a. The networked computer environment 100 may also include a server 112 that is enabled to run a cognitive application review program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

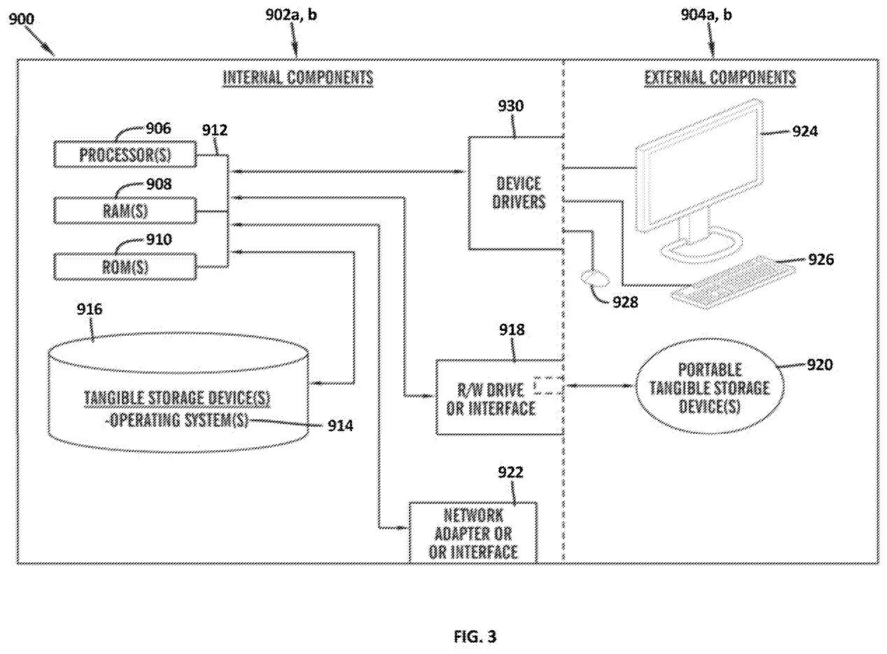

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the cognitive application review program 110a, 110b may interact with a database 114 that may be embedded in various storage devices, such as, but not limited to a computer/mobile device 102, a networked server 112, or a cloud storage service.

According to the present embodiment, a client computer 102 or a server computer 112 may execute instructions of the cognitive application review program 110a, 110b (respectively) to cognitively review an applicant's application by comparing the applicant's information to the job description and other applicants, rating the applicant's leadership, and by ranking applicants to recommend high ranking applicants to an administrator and provide feedback to low ranking applicants.

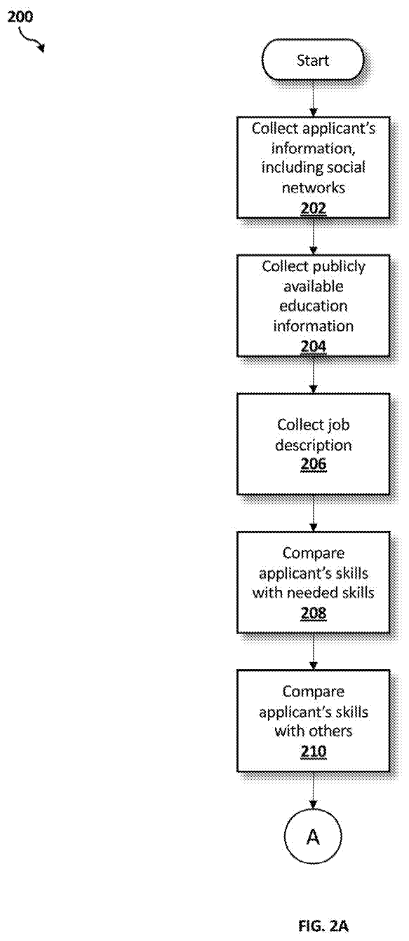

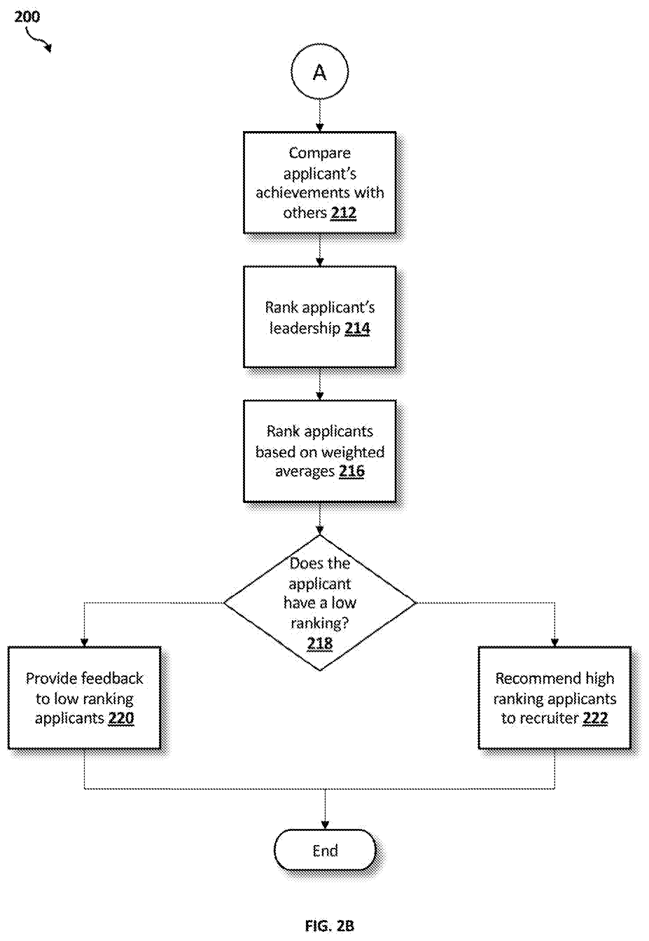

The cognitive application review method is explained in more detail below with respect to FIGS. 2A and 2B.

Referring now to FIGS. 2A and 2B, an operational flowchart illustrating the exemplary cognitive review process 200 used by the cognitive application review program 110a and 110b according to at least one embodiment is depicted. In various embodiments, the operations of the process 200 may be performed by any of the computer 102 or server 112 running the software program 108 and the cognitive application review programs 110a, 110b. In various embodiments, the operations of the process 200 may be included in any of the software program 108 and the cognitive application review program 110a, 110b.

At 202, publicly available education information is collected. Publicly available education information may be used to rate an applicant's educational background. A datastore may exist to store any publicly available information that may have been gathered in prior instances of the cognitive application review program 110a, 110b. Publicly available education information may also be used to recommend possible educational opportunities to applicants which may be included within the feedback provided to an applicant. For example, completion of an online class may be different than getting an A in an in-person college class. A culture of a school and/or an office may also be an important aspect to consider, as some applicants who may have taken classes at certain schools, for example, may do better in certain business environments than other applicants. Furthermore, achieving success at some schools and/or places of employment may be more difficult than at others.

At 204, applicant information is collected. Applicant information may include resume information, any social networks that the applicant engages with, and any publicly available information. Publicly available information and social network information, including publications, articles, patents, forums, and blogs, among other things, may be collected. For example, the present invention may utilize a combination of collected publicly available information to find that an applicant has published many articles in well-known journals. A datastore may exist to store any applicant information that may be gathered.

Skills and achievements of an applicant may also be collected. The determined skills of an applicant may vary based on an applicant's qualifications. For example, an applicant's completion of an online class may be weighted differently than another applicant's A in an in-person class. The details of how an applicant did and the content of the class may be important. A product certification may similarly carry more weight than a course completion. At times, professional certifications and/or published papers from qualified journals including but not limited to, The Open Group® (The Open Group is a registered trademark of The Open Group), The Institute of Electrical and Electronics Engineers, The Object Management Group® (The Object Management Group is a registered trademark of Object Management Group, Inc. in the United States and other countries), among others, may be considered more important than a product certification, a badge, and/or a course completion.

Many times, leadership in a given subject matter may not be determined based on academic qualifications, certifications, and/or badges, and may instead be determined by assessing the quality of an applicant's leadership based on mentoring, teaching, speaking, patenting, and/or publishing, among other things. Achievements may include recognitions, awards, patents, and/or published articles, among other things.

For example, a senior engineer at a company may want to start a mentorship program by mentoring new employees. The engineer may provide a detailed posting with a description of qualifications for the mentee position. A new employee who was recently hired may apply to the posting for the mentorship program. The cognitive application review program 110a, 110b may collect the new employee's information from the application which may include resume information, social network information, and publicly available information from the internet. From this collected information, the cognitive application review program 110a, 110b may establish the skills and achievements of the new employee.

As another example, an applicant may be looking to apply for a new job. The applicant may apply using a job posting website which may be managing and/or hosting the position that the applicant is interested in. Once the applicant applies, the cognitive application review program 110a, 110b may parse through the applicant's submitted data to determine the applicant's personal information, and may thereafter collect publicly available information about the applicant, using the personal information included on the applicant's application. The cognitive application review program 110a, 110b may find that the applicant runs a blog and may gather examples of Java™ (Java is a registered trademark of Oracle and/or its affiliates in the United States, and/or other countries) coding that the applicant has written. The cognitive application review program 110a, 110b may then establish that the applicant has experience and skills in the Java™ coding language, which may or may not be sufficient for the position the applicant has applied for. As another example, the cognitive application review program 110a, 110b may find that the applicant has contributed source code to an open source project or has answered a question about a programming language in a forum. The cognitive application review program 110a, 110b may determine that the applicant has a particular level of skill in a programming language based on the number or size of the source code contributions, on whether the source code contribution was used by others, on whether the source code contribution was commented on favorably or criticized by others in the open source community, or on whether an answer to a technical question posted by the applicant in an open source community forum was commented on favorably or criticized by others posting to the forum.

At 206, the job description from a job posting which the applicant is applying to is collected. For example, the job description may be posted by a company looking to hire a new applicant or by an individual looking for an internal mentee, among other things. The job description may include any skills, qualifications and/or experience (i.e., requirements) needed for the posted job. The present invention may extract the needed skills, qualifications and/or experiences for the posted job from the job description using natural language processing techniques.

For example, a company may create a job posting for a new open position. The job description may indicate that the applicant must be experienced with Microsoft® Excel (Microsoft Excel is a registered trademark or trademark of Microsoft Corporation in the United States and/or other countries). The cognitive application review program 110a, 110b may use natural language processing (NLP) techniques to parse the job description and to determine the specific requirements indicated by a hiring manager (i.e., the job poster). The cognitive application review program 110a, 110b may determine that the skill(s) needed for the position includes Microsoft® Excel and the level of skilled needed is experienced.

At 208, the skills of the applicant are compared to the requirements (e.g., the skills, qualifications, experiences) required to be demonstrated by an applicant for the posted job (i.e., position). An applicant may still be ranked by the cognitive application reviewer program if the skills of the applicant do not match the requirements (e.g., skills, qualifications, experiences). The applicant may be compared to the requirements for a posted job (i.e., a position) by rating the categories (e.g., education, skills, qualifications, achievements) that may have been defined by the administrator.

For example, a summer camp may be looking for past participants who may want to become camp counselors for the upcoming summer. An administrator for the summer camp may create a detailed job posting (i.e., a position) using the cognitive application review program 110a, 110b. The administrator may define four categories, including but not limited to, qualifications, education, skills, and leadership of an applicant which may be considered and rated during a review of the applicants' applications. The job posting (i.e., position) may include a description of the needed skills and qualifications for the camp counselor position. One requirement for the camp counselor position, among others, may be that the applicant has been a camp participant (e.g., a past camper) during one of the last two years. In this case, an applicant Taylor may be a camp participant who attended the camp three years ago and decides to apply to the posting (i.e., position). In this case, the cognitive application review program 110a, 110b may determine that Taylor does not meet the qualifications of the posted position and may give Taylor a low rating in the qualifications category. Despite this, Taylor may still receive a high rating in other categories (e.g., education, skills, leadership) and Taylor's application may still be recommended to the summer camp based on Taylor's other ratings.

At 210, the skills, qualifications and/or experiences of the applicant are compared to the skills, qualifications and/or experiences of other applicants for the same and/or a similar posted job. A posted job may be determined to be similar to one or more other posted jobs based on an analysis of the skills, qualifications and/or experiences extracted from the job description(s). For example, applicant A may have completed an online course in Java™ programming, while applicant B may have completed and received a grade of A in a college course in Java™ programming. Based on these facts, the cognitive application review program 110a, 110b may determine that applicant B is be more qualified in Java™ programming than applicant A.

At 212, the achievements of the applicant are compared to the achievements of the other applicants. Achievements may include recognitions, awards, patents, and/or published articles, among other things.

For example, a prestigious college preparatory program may use the cognitive application review program 110a, 110b to identify qualified applicants. Kelly and Amy may both be high school students from the same high school. Kelly and Amy may both be in the same classes and may have received similar grades in their classes, so the cognitive application review program 110a, 110b may find both Kelly and Amy have similar skills based on their educational background. However, when reviewing Kelly and Amy's achievements, the cognitive application review program 110a, 110b may discover that Kelly won first place in a recent math competition while Amy did not place in the same competition. Based on the above, the cognitive application review program 110a, 110b may rate Kelly's achievements higher than Amy's. This may be an important factor in identifying qualified applicants for the prestigious college preparatory program.

At 214, the leadership qualities of an applicant (e.g., any leadership initiatives undertaken by the applicant) are identified using social networking and are rated. The present invention may ingest social networks, blogs, and/or historical work reports. Natural language processing techniques may be used to identify applicants that may be early and/or late on tasks. Natural language processing techniques may also be used to identify individuals that may be inclined to assist others on tasks (i.e., assisting others). Natural language processing techniques, such as those implemented in Watson™ (Watson and all Watson-based trademarks are trademarks or registered trademarks of International Business Machines Corporation in the United States, and/or other countries) application program interfaces (APIs) (e.g., a personality insights API such as Watson™ Personality Insights API) may be used by embodiments of the present invention. A leadership rating of an applicant may be created by weighing the above qualities and/or skills. If a leadership rating may not be obtained, for example if the applicant does not have any social networking accounts, blogs, or historical work reports to analyze, then the category of leadership may not be utilized for ranking the applicant.

At 216, the rank of the applicant is determined based on weighted averages. The rank of an applicant may be based on the applicant's compiled numeric average (i.e., weighted average) as compared to other applicants. The weighted averages are compiled by assessing all candidates who applied to the job posting and may include all factors that may have been analyzed (e.g., skills/experience relative to the job posting, as well as education, among other things). A higher weight may be assigned by an administrator or other user of the cognitive application review program 110a, 110b, to a more important factor, based on a business priority or other consideration. A lower weight may similarly be assigned by an administrator or other user of the cognitive application review program 110a, 110b, to factors of an application which are determined to be less valuable, based on a review of the job function.

For example, a company may be looking for an experienced Java™ (Java is a registered trademark of Oracle and/or its affiliates in the United States, and/or other countries) developer. An administrator from the company may provide a detailed job posting with a description of the needed requirements for the position. The administrator may define three categories: education, skills, and leadership, to be ranked by the cognitive application review program 110a, 110b. The administrator may also decide, based on the priorities of the company, that the category of education may be weighted the most heavily, as compared to the categories of skills and leadership, when ranking any applicants. George may be looking for a job and the company's job posting may catch George's eye, causing him to apply. At the same time, Mike may be looking at the same job posting as George. Both George and Mike may have similar resumes. The cognitive application review program 110a, 110b may determine that George has a more advanced Java™ education (e.g., a high rating in the education category) because he teaches an advanced Java™ class, according to the cognitive application review program's 110a, 110b review and interpretation of George's application. The cognitive application review program 110a, 110b may determine that both applicants have a similar rating in the skills category. However, the cognitive application review program 110a, 110b may determine that Mike gets work done quicker (e.g. a high rating in the leadership category) than George based on a review of Mike's historical work reports. Based on the above, and based on the priorities of the company, the cognitive application review program 110a, 110b may rank George's application higher than Mike's.

At 218, the cognitive application review program 110a, 110b determines whether the applicant has a low ranking. A low ranking may be comparatively low as compared to the rankings of other applicants who may have applied for the same or a similar posting (i.e., a posted job). A low ranking may also be determined to be low based on a threshold ranking inputted by an administrator or other user of the cognitive application review program 110a, 110b (e.g., any ranking below the threshold ranking may be considered a low ranking and any ranking above the threshold ranking may be considered a high ranking). As will be described in more detail with respect to step 220 below, the present invention may provide feedback to applicants based on the applicant's ranking.

At 220, feedback is provided to applicants determined to have a comparatively low ranking. A low ranking may be a comparatively low ranking as compared to the rankings of other applicants who may have applied for the same or a similar posting (i.e., a posted job). For example, based on a comparison of rankings among applicants, feedback may be provided to the lowest three applicants, based on a predefined setting inputted by an administrator and/or other user of the cognitive application review program 110a, 110b. Feedback may alternatively be provided to all applicants with ranks determined to be lower than the most qualified applicant, among other combinations of applicants, based on a predefined setting. Feedback may include an identification of areas that may lack details in the application and/or a suggestion of future educational opportunities, among other things.

Suggestions of future educational opportunities may, for example, be based on information gathered after a review of other applications and/or connected database(s) of educational resources.

For example, Tom may be looking to apply for a new job. Tom may send his application through a job posting website that may be managing an opening that Tom is interested in. The cognitive application review program 110a, 110b may rate Tom's education category as a 4 on a scale of 1 to 10, while Tom's other categories (e.g., skills, qualifications, achievements, and leadership) may be rated more highly. The low rating in the education category may have caused Tom to be low ranking as compared to other applicants. Based on the analysis performed by the cognitive application review program 110a, 110b, the present invention may provide feedback and report to Tom that his educational background may be weak. Tom may realize that he forgot to include some classes and he may accordingly update his resume. Tom may then receive an updated rating of 7 for the education category.

As another example, a local hospital may be looking for volunteers. The hospital may provide a detailed posting with a description of the needed skills and qualifications for the volunteer position. Sarah may be a high school student looking to apply as a volunteer at the hospital. Sarah may apply to the posting. At the same time, Liz, a nursing student in college, may also apply to the posting. The cognitive application review program 110a, 110b may determine that Liz has a more advanced health education because she has taken advanced biology courses while Sarah has a less advanced health education because she has only taken a high school biology course, according to the cognitive application review program's 110a, 110b review and interpretation of Liz and Sarah's applications. The cognitive application review program 110a, 110b may rate Liz's skills and education categories as highly rated, while Sarah's skills and education categories may not be highly rated. Based on the above, the cognitive application review program 110a, 110b may rank Liz's application ahead of Sarah's. The cognitive application review program 110a, 110b may suggest local community college health science and/or biology courses to Sarah that may improve her application in the future.

At 222, the cognitive application review program 110a, 110b recommends comparatively high-ranking applicants to an administrator, a recruiter, and/or another individual who may have posted the position (i.e., the posting, the posted job). A high ranking may be a comparatively high ranking as compared to the rankings of other applicants who may have applied for the same or a similar position (i.e., the posting, the posted job). The recommended applicants may be selected to interview for the position first, or before an applicant with a lower ranking. Selection for interviews may be based on dynamic input from the administrator, recruiter, and/or individual who posted the position. There may be an initial input by an administrator of the cognitive application review program 110a, 110b, for example, that three applicants be selected for interview. However, after interviewing the first selected applicant, the administrator may determine that the second and third interviews are no longer required. Thus, the administrator may update the cognitive application review program 110a, 110b to reflect this information, which may dynamically modify the recommendation.

For example, Mary and Mark may both be applying for the same job within the cloud architecture division of their corporation. Mary's experience and credentials may include acclaimed papers, which she authored, as well as reputed publications on cloud architecture. Mary may also mentor individuals within the organization on cloud-based solutions and implementations. Mark may be an acclaimed certified cloud architect. However, the cognitive application review program 110a, 110b may determine that Mark's experience may not show deep knowledge of real cloud architecture implementations and may thus rank Mary ahead of Mark for the posted job. As a result, the cognitive application review program 110a, 110b may also recommend that Mary be interviewed first.

It may be appreciated that FIGS. 2A AND 2B provides only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902a, b and external components 904a, b illustrated in FIG. 3. Each of the sets of internal components 902a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the cognitive application review program 110a in client computer 102, and the cognitive application review program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the cognitive application review program 110a and 110b can be stored on one or more of the respective portable computer-readable tangible storage devices 920, read via the respective R/W drive or interface 918 and loaded into the respective hard drive 916.

Each set of internal components 902a, b may also include network adapters (or switch port cards) or interfaces 922 such as a TCP/IP adapter cards, wireless wi-fi interface cards, or 3G or 4G wireless interface cards or other wired or wireless communication links. The software program 108 and the cognitive application review program 110a in client computer 102 and the cognitive application review program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the cognitive application review program 110a in client computer 102 and the cognitive application review program 110b in network server computer 112 are loaded into the respective hard drive 916. The network may comprise copper wires, optical fibers, wireless transmission, routers, firewalls, switches, gateway computers and/or edge servers.

Each of the sets of external components 904a, b can include a computer display monitor 924, a keyboard 926, and a computer mouse 928. External components 904a, b can also include touch screens, virtual keyboards, touch pads, pointing devices, and other human interface devices. Each of the sets of internal components 902a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

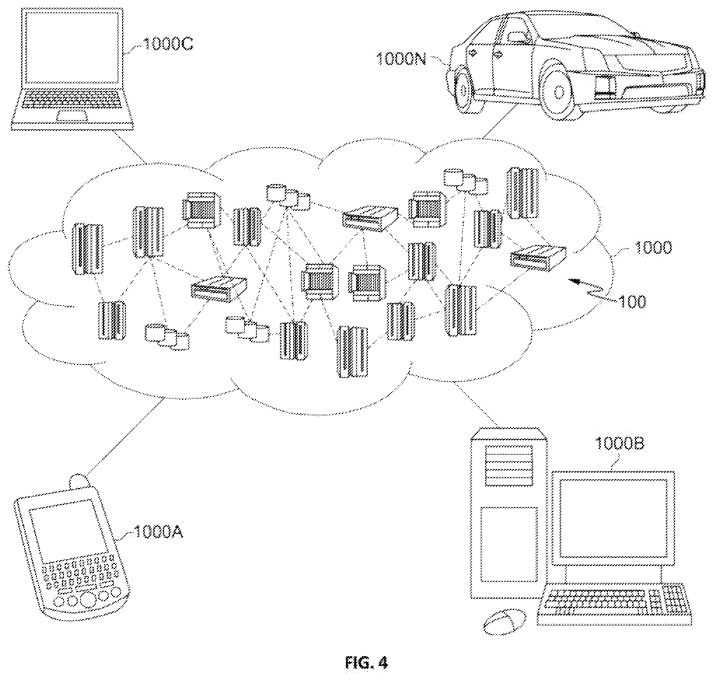

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

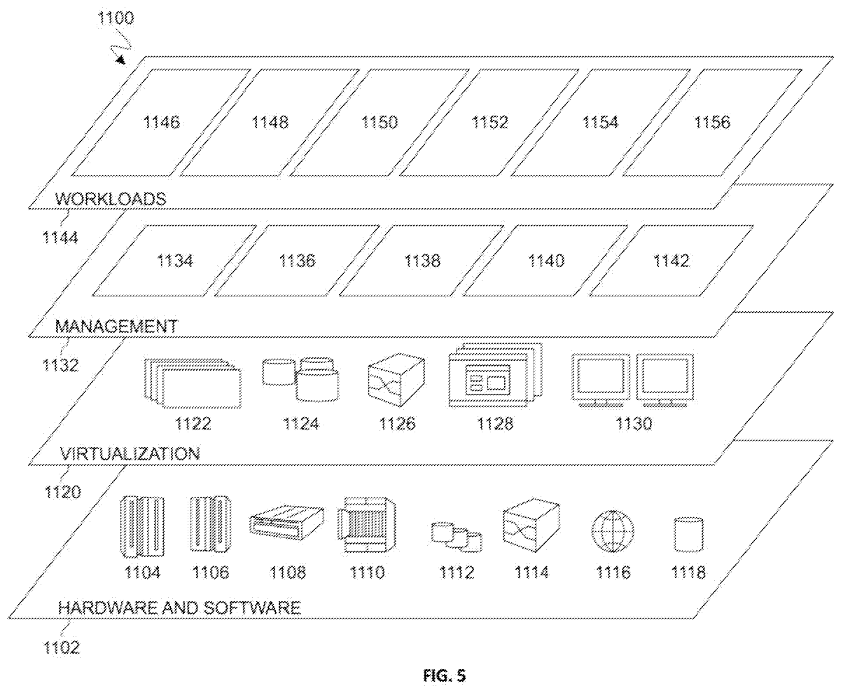

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and cognitive review 1156. A cognitive application review program 110a, 110b provides a way to cognitively review an applicant's application by comparing the applicant's information to the job description and other applicants, rating the applicant's leadership, and by ranking applicants to recommend high ranking applicants to an administrator and provide feedback to low ranking applicants.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for cognitive application review, the method comprising:
receiving, by a processor, an applicant's application based on a job description;
collecting, by the processor, publicly available education information;
collecting, by the processor, publicly available information about the applicant;
comparing, by the processor, the publicly available information about the applicant, as well as information included on the applicant's application, to the job description;
comparing, by the processor, one or more skills and achievements of the applicant to one or more skills and achievements of other applicants;
rating, by the processor, one or more qualities, including a leadership quality, of the applicant;
ranking, by the processor, the applicant, based on the one or more rated qualities;
identifying, by the processor, a low ranking applicant and providing feedback to the low ranking applicant; and
recommending, by the processor, a high ranking applicant to an administrator.

2. The method of claim 1, wherein collecting, by the processor, publicly available information about the applicant further comprises:
searching at least one public datastore for publicly available information;
storing publicly available information in a private datastore;

3. The method of claim 1, wherein comparing, by the processor, the publicly available information about the applicant, as well as information included on the applicant's application, to the job description further comprises:
calculating a rating for each of one or more categories, wherein the one or more categories is defined by an administrator, based on evaluating the job description.

4. The method of claim 1, wherein rating, by the processor, one or more qualities, including the leadership quality, of the applicant further comprises:
searching at least one publicly available datastore, including a social network, a blog, or a historical work report;
identifying one or more leadership qualities of the applicant; and
calculating a leadership rating for the applicant based on the identified leadership qualities.

5. The method of claim 4, wherein leadership qualities include timeliness of tasks and assisting others.

6. The method of claim 1, wherein ranking, by the processor, the applicant, based on the one or more rated qualities further comprises:
calculating a weighted average by assessing the rated qualities and weighing each of the rated qualities based on a defined preference of the administrator.

7. The method of claim 1, wherein identifying, by the processor, the low ranking applicant and providing feedback to the low ranking applicant further comprises:
comparing a ranking of the applicant to a ranking of at least one other applicant; and
generating feedback for the applicant, wherein the generated feedback includes one or more weak areas in the applicant's application and a suggestion for one or more future educational opportunities.

8. A computer system for cognitive application review, the method comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving, by a processor, an applicant's application based on a job description;
collecting, by the processor, publicly available education information;
collecting, by the processor, publicly available information about the applicant;
comparing, by the processor, the publicly available information about the applicant, as well as information included on the applicant's application, to the job description;
comparing, by the processor, one or more skills and achievements of the applicant to one or more skills and achievements of other applicants;
rating, by the processor, one or more qualities, including a leadership quality, of the applicant;
ranking, by the processor, the applicant, based on the one or more rated qualities;
identifying, by the processor, a low ranking applicant and providing feedback to the low ranking applicant; and
recommending, by the processor, a high ranking applicant to an administrator.

9. The computer system of claim 8, wherein collecting, by the processor, publicly available information about the applicant further comprises:
searching at least one public datastore for publicly available information; and
storing publicly available information in a private datastore;

10. The computer system of claim 8, wherein comparing, by the processor, the publicly available information about the applicant, as well as information included on the applicant's application, to the job description further comprises:
calculating a rating for each of one or more categories, wherein the one or more categories is defined by an administrator, based on evaluating the job description.

11. The computer system of claim 8, wherein rating, by the processor, one or more qualities, including the leadership quality, of the applicant further comprises:
searching at least one publicly available datastore, including a social network, a blog, or a historical work report;
identifying one or more leadership qualities of the applicant; and
calculating a leadership rating for the applicant based on the identified leadership qualities.

12. The computer system of claim 11, wherein leadership qualities include timeliness of tasks and assisting others.

13. The computer system of claim 8, wherein ranking, by the processor, the applicant, based on the one or more rated qualities further comprises:
calculating a weighted average by assessing the rated qualities and weighing each of the rated qualities based on a defined preference of the administrator.

14. The computer system of claim 8, wherein identifying, by the processor, the low ranking applicant and providing feedback to the low ranking applicant further comprises:
comparing a ranking of the applicant to a ranking of at least one other applicant; and
generating feedback for the applicant, wherein the generated feedback includes one or more weak areas in the applicant's application and a suggestion for one or more future educational opportunities.

15. A computer program product for cognitive application review, the method comprising:
one or more non-transitory computer-readable storage media and program instructions stored on at least one of the one or more tangible storage media, the program instructions executable by a processor to cause the processor to perform a method comprising:
receiving, by a processor, an applicant's application based on a job description;
collecting, by the processor, publicly available education information;
collecting, by the processor, publicly available information about the applicant;
comparing, by the processor, the publicly available information about the applicant, as well as information included on the applicant's application, to the job description;
comparing, by the processor, one or more skills and achievements of the applicant to one or more skills and achievements of other applicants;
rating, by the processor, one or more qualities, including a leadership quality, of the applicant;
ranking, by the processor, the applicant, based on the one or more rated qualities;
identifying, by the processor, a low ranking applicant and providing feedback to the low ranking applicant; and
recommending, by the processor, a high ranking applicant to an administrator.

16. The computer program product of claim 15, wherein collecting, by the processor, publicly available information about the applicant further comprises:
searching at least one public datastore for publicly available information; and
storing publicly available information in a private datastore;

17. The computer program product of claim 15, wherein comparing, by the processor, the publicly available information about the applicant, as well as information included on the applicant's application, to the job description further comprises:
calculating a rating for each of one or more categories, wherein the one or more categories is defined by an administrator, based on evaluating the job description.

18. The computer program product of claim 15, wherein rating, by the processor, one or more qualities, including the leadership quality, of the applicant further comprises:
searching at least one publicly available datastore, including a social network, a blog, or a historical work report;
identifying one or more leadership qualities of the applicant; and
calculating a leadership rating for the applicant based on the identified leadership qualities.

19. The computer program product of claim 15, wherein leadership qualities include timeliness of tasks and assisting others.

20. The computer program product of claim 15, wherein ranking, by the processor, the applicant, based on the one or more rated qualities further comprises:
calculating a weighted average by assessing the rated qualities and weighing each of the rated qualities based on a defined preference of the administrator.
